(19) United States
(12) Patent Application Publication
(10) Pub. No.: US 2016/0013457 A1
(43) Pub. Date: Jan. 14, 2016

(54) FLEXIBLE SECONDARY BATTERY

(71) Applicant: Samsung SDI Co., Ltd., Yongin-si (KR)

(72) Inventors: Junwon Suh, Yongin-si (KR); Jeong-Doo Yi, Yongin-si (KR); Juhee Sohn, Yongin-si (KR); Hyunhwa Song, Yongin-si (KR)

(21) Appl. No.: 14/679,988

(22) Filed: Apr. 6, 2015

(30) Foreign Application Priority Data
Jul. 14, 2014 (KR) 10-2014-0088451

(51) Int. Cl. H01M 2/02; H01M 2/08

(52) U.S. Cl. CPC H01M 2/0202; H01M 2/08; H01M 2220/30

(57) ABSTRACT

Provided is a flexible secondary battery including: an electrode assembly including a first electrode layer, a second electrode layer, and a separator between the first electrode layer and the second electrode layer; a flexible gasket surrounding edges of the electrode assembly; a first sealing sheet attached to a first surface of the gasket; and a second sealing sheet attached to a second surface of the gasket facing away from the first surface, wherein the gasket includes a first layer and a second layer formed of the same material and an intermediate layer formed between the first layer and the second layer and formed of a material that is different from the material of the first layer and the second layer.

### CROSS-REFERENCE TO RELATED APPLICATION

This application claims priority to and the benefit of Korean Patent Application No. 10-2014-0088451, filed on Jul. 14, 2014, in the Korean Intellectual Property Office, the entire content of which is incorporated herein by reference.

### BACKGROUND

1. Field

One or more embodiments of the present invention relate to a flexible secondary battery.

2. Description of the Related Art

As electronic technology has developed, the market for various mobile electronic devices such as smart phones, smart pads, e-book readers, flexible tablet computers, or wearable medical devices as well as mobile phones, game players, portable multimedia players (PMPs), or MPEG audio layer-3 (MP3) players has greatly grown.

As the market for mobile electronic devices has grown, the demand for batteries suitable for the mobile electronic devices has also increased. As the demand for flexible mobile electronic devices to improve utility, mobility, storage, and impact resistance has increased, the demand for flexible batteries that are provided in the flexible mobile electronic devices has also increased.

### SUMMARY

One or more embodiments of the present invention are directed toward a flexible secondary battery, which may maintain stability even after the flexible secondary battery is repeatedly bent.

Additional aspects of embodiments will be set forth in part in the description which follows and, in part, will be apparent from the description, or may be learned by practice of the presented embodiments.

According to one or more embodiments of the present invention, a flexible secondary battery includes: an electrode assembly including a first electrode layer, a second electrode layer, and a separator between the first electrode layer and the second electrode layer; a gasket having flexibility and surrounding an edge of the electrode assembly; a first sealing sheet attached to a first surface of the gasket; and a second sealing sheet attached to a second surface of the gasket facing away from the first surface, wherein the gasket includes a first layer and a second layer comprising a same material and an intermediate layer formed between the first layer and the second layer of a material that is different from the material of the first layer and the second layer.

A modulus of elasticity of the intermediate layer may be different from a modulus of elasticity of each of the first layer and the second layer.

The first layer and the second layer may contact each other at an edge of the intermediate layer.

The flexible secondary battery may further include adhesive layers between the first layer and the intermediate layer and between the second layer and the intermediate layer.

The gasket may have a thickness of about 80% to about 120% of a thickness of the electrode assembly.

Each of the first sealing sheet and the second sealing sheet may include a first insulating layer, a metal layer, and a second insulating layer, wherein the first insulating layer contacts the gasket, and the first insulating layer, the first layer, and the second layer are include materials that are the same.

The intermediate layer may include silicon, polyethyleneterephthalate (PET), urethane, or a shape memory alloy.

The intermediate layer may include a first intermediate layer, a second intermediate layer formed on a first surface of the first intermediate layer, and a third intermediate layer formed on a second surface of the first intermediate layer, wherein the first intermediate layer includes a shape memory alloy, and each of the second intermediate layer and the third intermediate layer include silicon or PET.

The first electrode layer may include a first active material unit, the first active material unit including a first metal current collector coated with a first active material, and a first non-coated portion on which the first active material is not coated and to which a first electrode tab is attached, and the second electrode layer may include a second active material unit, the second active material unit including a second metal current collector coated with a second active material, and a second non-coated portion on which the second active material is not coated and to which a second electrode tab is attached.

The first electrode tab and the second electrode tab may protrude to the outside between the gasket and the first sealing sheet or between the gasket and the second sealing sheet.

The gasket may include a first lead electrode and a second lead electrode passing through one side of the gasket.

The first lead electrode may be attached to the first electrode tab and the second lead electrode is attached to the second electrode tab in an internal space of the gasket.

The electrode assembly may further include a fixing member fixing one end portion of each of the first electrode layer, the separator, and the second electrode layer together.

### BRIEF DESCRIPTION OF THE DRAWINGS

These and/or other aspects will become apparent and more readily appreciated from the following description of the embodiments, taken in conjunction with the accompanying drawings in which:

FIG. 1 is an exploded perspective view illustrating a flexible secondary battery according to an embodiment of the present invention;

FIG. 2 is a plan view illustrating an electrode assembly of the flexible secondary battery of FIG. 1;

FIG. 3 is a cross-sectional view taken along line I-I of FIG. 2;

FIG. 4 is a cross-sectional view taken along line II-II of FIG. 1, according to an embodiment of the present invention;

FIG. 5 is a cross-sectional view taken along line II-II of FIG. 1, according to another embodiment of the present invention;

FIG. 6 is a graph illustrating a capacity retention rate after repeated bending cycles of the flexible secondary battery of FIG. 1;

FIG. 7 is an exploded perspective view illustrating a flexible secondary battery that is a modification of the flexible secondary battery of FIG. 1; and

FIG. 8 is a plan view illustrating a gasket of the flexible secondary battery of FIG. 7.

### DETAILED DESCRIPTION

The present invention may include various embodiments and modifications, and exemplary embodiments thereof are illustrated in the drawings and are described herein in detail. The effects and features of the present invention and the accompanying methods thereof should be apparent from the following description of the embodiments, taken in conjunction with the accompanying drawings. However, the present invention is not limited to the embodiments described herein, and may be embodied in various modes (or many different forms).

Reference will now be made to embodiments of the invention, examples of which are illustrated in the accompanying drawings. In the drawings, the same elements are denoted by the same reference numerals, and an explanation thereof will not be repeated herein.

It will be understood that although the terms “first”, “second”, etc. may be used herein to describe various elements, these elements should not be limited by these terms. These elements are only used to distinguish one element from another.

As used herein, the singular forms “a,” “an” and “the” are intended to include the plural forms as well, unless the context clearly indicates otherwise.

It will be further understood that the terms “comprises” and/or “comprising” used herein specify the presence of the stated features or components, but do not preclude the presence or addition of one or more additional features or components.

It will be understood that when an element is referred to as being “on” or “formed on,” another element, it can be directly or indirectly on or formed on the other element. For example, intervening elements may also be present. Further, when an element is referred to as being “connected to” another element, it can be directly connected to the other element or indirectly connected to the other element with one or more intervening elements interposed therebetween.

Sizes of elements may be exaggerated for convenience of explanation. In other words, since sizes and thicknesses of elements in the drawings may be arbitrarily illustrated for convenience of explanation, the following embodiments are not limited thereto.

As used herein, the term “and/or” includes any and all combinations of one or more of the associated listed items. Expressions such as “at least one of,” when preceding a list of elements, modify the entire list of elements and do not modify the individual elements of the list.

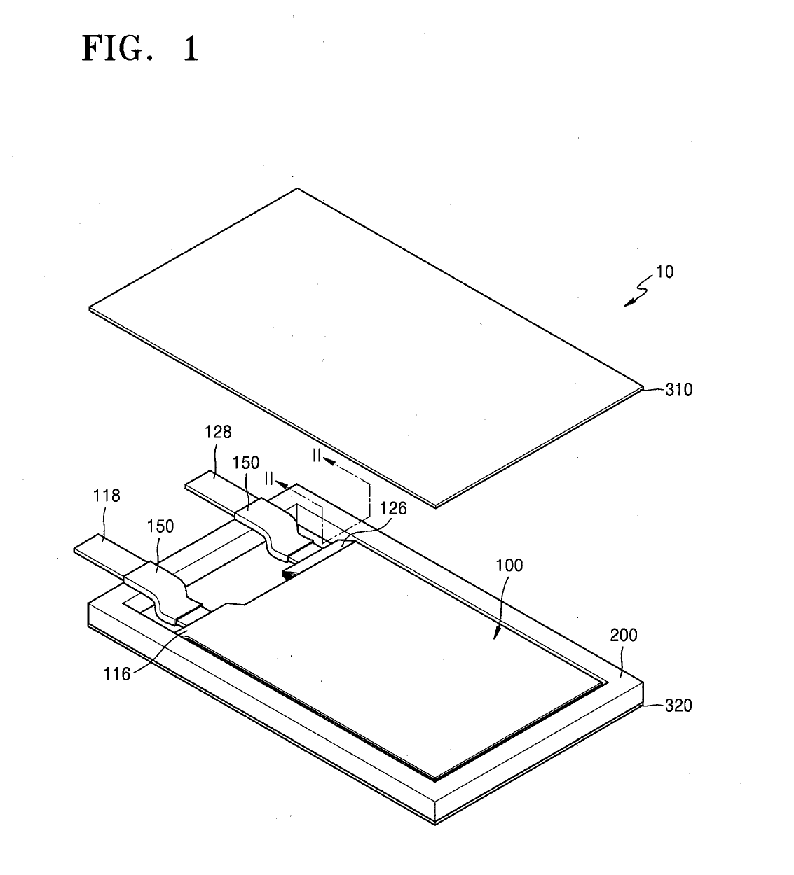

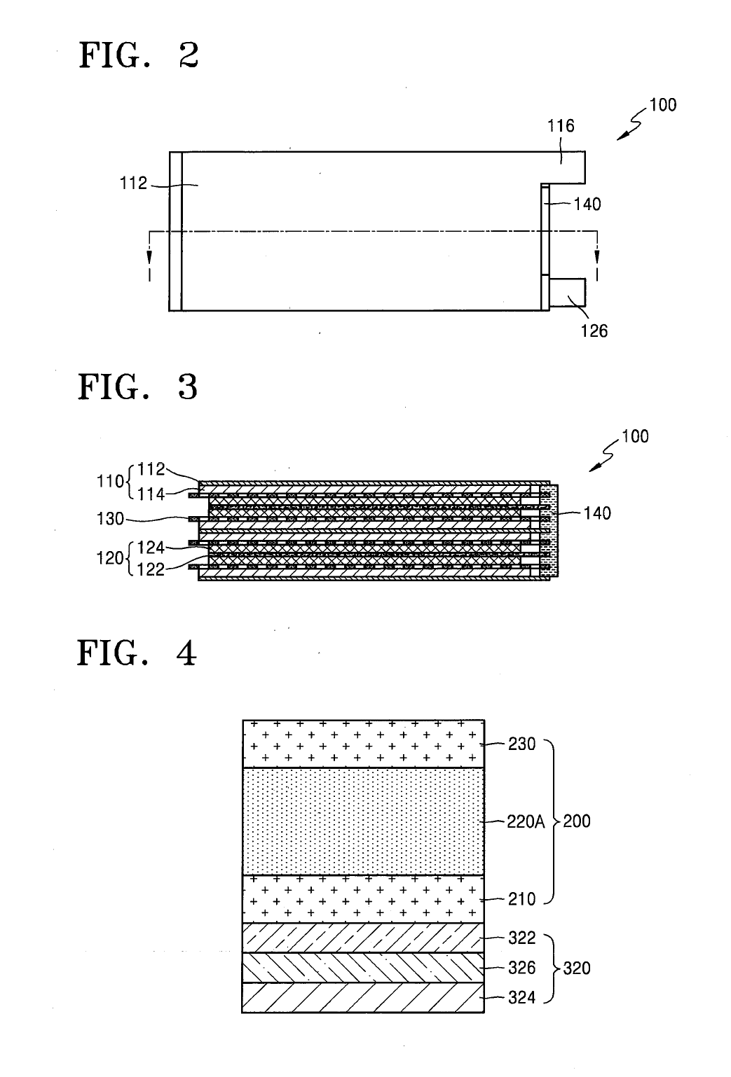

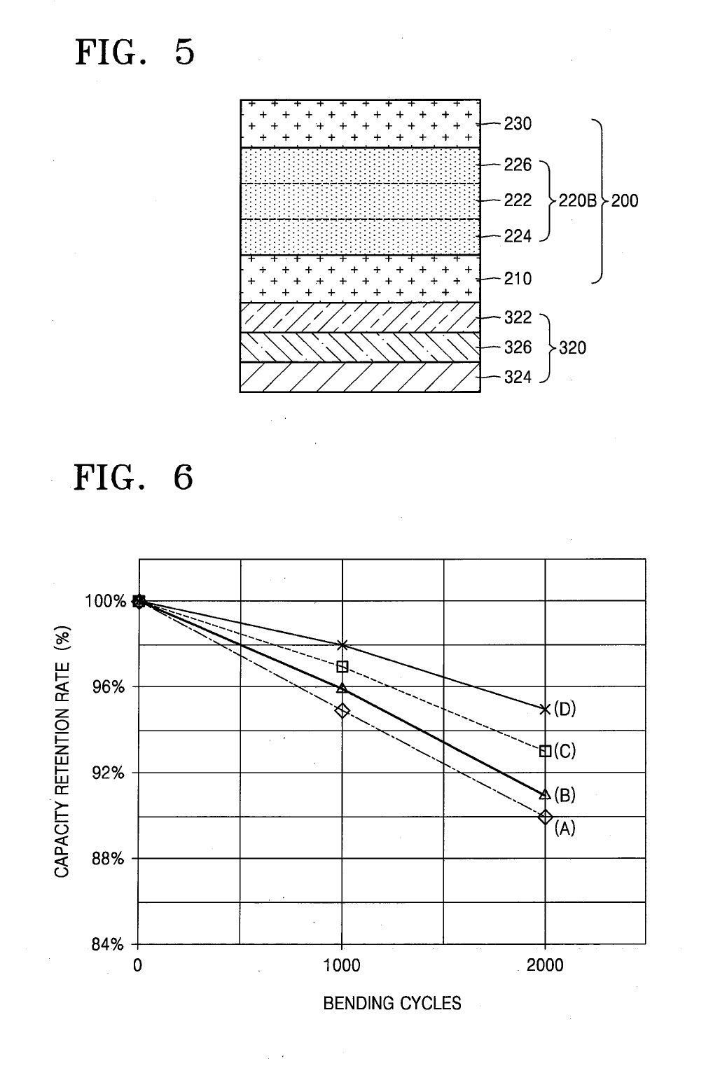

FIG. 1 is an exploded perspective view illustrating a flexible secondary battery 10 according to an embodiment of the present invention. FIG. 2 is a plan view illustrating an electrode assembly 100 of the flexible secondary battery 10 of FIG. 1. FIG. 3 is a cross-sectional view taken along the line II of FIG. 2. FIG. 4 is a cross-sectional view taken along line II-II of FIG. 1, according to an embodiment of the present invention. FIG. 5 is a cross-sectional view taken along line II-II of FIG. 1, according to another embodiment of the present invention. FIG. 6 is a graph illustrating a capacity retention rate of the flexible secondary battery 10 of FIG. 1 after repeated bending cycles.

Referring to FIGS. 1 through 4, the flexible secondary battery 10 may include the electrode assembly 100, a gasket 200 that surrounds an edge of the electrode assembly 100, a first sealing sheet 310 that is attached to a first surface of the gasket 200, and a second sealing sheet 320 that is attached to a second surface of the gasket 200 that is opposite to the first surface.

The electrode assembly 100 may include a first electrode layer 110, a second electrode layer 120, and a separator 130 between the first electrode layer 110 and the second electrode layer 120. For example, the electrode assembly 100 may have a structure in which a plurality of the first electrode layers 110, a plurality of the separators 130, and a plurality of the second electrode layers 120 are repeatedly stacked (i.e., a structure including the first electrode layer 110, the separator 130, and the second electrode layer 120 stacked in that order is repeated).

The first electrode layer 110 may be any one of a positive film and a negative film. When the first electrode layer 110 is a positive film, the second electrode layer 120 may be a negative film. Alternatively, when the first electrode layer 110 is a negative film, the second electrode layer 120 may be a positive film.

The first electrode layer 110 may include a first metal current collector 112, a first active material unit 114 including (e.g., that is formed by coating a surface of the first metal current collector 112 with) a first active material, and a first non-coated portion 116 on which the first active material is not coated. Similarly, the second electrode layer 120 may include a second metal current collector 122, a second active material unit 124 including (e.g., that is formed by coating a surface of the second metal current collector 122 with) a second active material, and a second non-coated portion 126 on which the second active material is not coated.

When the first electrode layer 110 is a positive film, the first metal current collector 112 may be a positive current collector and the first active material unit 114 may be a positive active material unit. When the second electrode layer 120 is a negative film, the second metal current collector 122 may be a negative current collector and the second active material unit 124 may be a negative active material unit.

The positive current collector (e.g., the first metal current collector 112 or the second metal current collector 122) may include (or be formed of) aluminum, stainless steel, titanium, silver, or a combination thereof. The positive active material unit (e.g., the first active material unit 114 or the second active material unit 124) may include a positive active material, a binder, and a conductive material.

The positive active material may include (or be) a material that may reversibly occlude and release lithium ions. For example, the positive active material may include at least one selected from the group consisting of a lithium transition metal oxide (e.g., lithium cobalt oxide, lithium nickel oxide, lithium nickel cobalt oxide, lithium nickel cobalt aluminum oxide, lithium nickel cobalt manganese oxide, lithium manganese oxide, or lithium iron phosphate), nickel sulfide, copper sulfide, sulfur, iron oxide, and vanadium oxide.

The binder may include at least one selected from the group consisting of a polyvinylidene fluoride-based binder (e.g., polyvinylidene fluoride, vinylidene fluoride/hexafluoropropylene copolymer, or vinylidene fluoride/tetrafluoroethylene copolymer), a carboxymethyl cellulose-based binder (e.g., sodium-carboxymethyl cellulose or lithium-carboxymethyl cellulose), an acrylate-based binder (e.g., polyacrylic acid, lithium-polyacrylic acid, acryl, polyacrylonitrile, polymethyl methacrylate, or polybutyl acrylate), polyamideimide, polytetrafluoroethylene, polyethylene oxide, polypyrrole, lithium-nafion, and a styrene butadiene rubber-based polymer.

The conductive material may include at least one selected from the group consisting of a carbon-based conductive material (e.g., carbon black, carbon fiber, or graphite), a conductive fiber (e.g., a metal fiber, metal powder such as carbon fluoride powder, aluminum powder, or nickel powder), a conductive whisker (e.g., zinc oxide or potassium titanate), a conductive metal oxide (e.g., titanium oxide), and a conductive polymer (e.g., a polyphenylene derivative).

The negative current collector may include at least one metal selected from the group consisting of copper, stainless steel, nickel, and titanium. The negative active material unit may include a negative active material, a binder, and a conductive material.

The negative active material may include a material that may form (or become) an alloy with lithium, or may reversibly occlude or release lithium. For example, the negative active material may include at least one selected from the group consisting of a metal, a carbon-based material, a metal oxide, and a lithium metal nitride.

The metal may include at least one selected from the group consisting of lithium, silicon, magnesium, calcium, aluminum, germanium, tin, lead, arsenic, antimony, bismuth, silver, gold, zinc, cadmium, mercury, copper, iron, nickel, cobalt, and indium.

The carbon-based material may include at least one selected from the group consisting of graphite, graphite carbon fiber, coke, mesocarbon microbeads (MCMB), polyacene, pitch-based carbon fiber, and hard carbon.

The metal oxide may include at least one selected from the group consisting of lithium titanium oxide, titanium oxide, molybdenum oxide, niobium oxide, iron oxide, tungsten oxide, tin oxide, amorphous tin mixed oxide, silicon monoxide, cobalt oxide, and nickel oxide.

The binder and the conductive material of the negative active material unit may be the same as those described with respect to the positive active material unit, but the binder and the conductive material of the negative active material unit may be selected independently of the binder and the conductive material of the positive active material unit.

The separator 130 may be formed, but is not limited to, by coating at least one material selected from the group consisting of polyethylene (PE), polystyrene (PS), polypropylene (PP), and a co-polymer of PE and PP with polyvinylidene fluoride cohexafluoropropylene (PVDF-HFP) co-polymer.

A first electrode tab 118 and a second electrode tab 128 are attached to the electrode assembly 110. For example, the first electrode tab 118 and the second electrode tab 128 may be respectively attached by using welding or the like to a plurality of the first non-coated portions 116 and a plurality of the second non-coated portions 126 that are stacked.

The electrode assembly 100 may further include a fixing member 140 that fixes one end portion of each of the first electrode layer 110, the separator 130, and the second electrode layer 120 together. The fixing member 140 between the first non-coated portion 116 and the separator 130 and between the separator 130 and the second non-coated portion 126 may be, but is not limited to, an adhesive or a tape to which an adhesive is applied.

The fixing member 140 does not fix a portion of the first electrode layer 110, the separator 130, or the second electrode layer 120 other than the one end portion of each of the first electrode layer 110, the separator 130, and the second electrode 120 (e.g., fixing member 140 fixes only the one end portion of each of the first electrode layer 110, the separator 130, and the second electrode layer 120). Accordingly, in an area where the fixing member 140 is not formed, the electrode assembly 100 may bend due to slippage between the first electrode 110, the separator 130, and the second electrode layer 120, and relative positions of the first electrode layer 110, the separator 130, and the second electrode layer 120 may be maintained by the fixing member 140 even when the electrode assembly 100 repeatedly bends.

The fixing member 140 may be at (or on or formed on) the same side of the electrode assembly 100 as the first electrode tab 118 and the second electrode tab 128 in a longitudinal direction of the electrode assembly 100.

Another end portion of each of the first electrode 110, the separator 130, and the second electrode layer 120 at (or on) which the fixing member 140 is not formed undergoes greater displacement than the one end portion of each of the first electrode layer 110, the separator 130, and the second electrode layer 120 at (or on) which the fixing member 140 is formed when the electrode assembly 100 bends. Since the first electrode tab 118 may be attached to (e.g., adhered to) the plurality of first non-coated portions 116 and the second electrode tab 128 may be attached to (e.g., adhered to) the plurality of second non-coated portions 126, the first electrode tab 118 and the second electrode tab 128 may be actually respectively used as fixing units for fixing the first electrode layers 110 and the second electrode layers 120.

Accordingly, when the fixing member 140 is at (or on or formed on) a side of the electrode assembly 110 opposite to the first electrode tab 118 (e.g., a side facing away from the first electrode tab 118) and opposite to the second electrode tab 128 (e.g., a side facing away from the second electrode tab 128) in the longitudinal direction of the electrode assembly 100, and when the electrode assembly 100 bends, the first electrode layer 110 and/or the second electrode layer 120 may bend between the first and second electrode tabs 118 and 128 and the fixing member 140 and a part of the fixing member 140 may be destroyed, thereby making it difficult to maintain alignment between the first electrode layer 110, the separator 130, and the second electrode layer 120.

A protective layer may be at (or on or formed on) an outermost surface of the electrode assembly 100. The protective layer may prevent the first electrode layer 110, the separator 130, or the second electrode layer 120 from wrinkling when the electrode assembly 100 bends. For example, when the electrode assembly 100 bends, the first electrode layer 110, the separator 130, and the second electrode layer 120 tend to wrinkle in order to reduce a compressive stress. When the first electrode layer 110, the separator 130, or the second electrode layer 120 would otherwise undergo deformation with a small radius of curvature, such as a wrinkle, the protective layer may prevent (or reduce) greater deformation by pressing down the first electrode layer 110, the separator 130, or the second electrode 120 and may reduce a stress applied to the first electrode 110, the separator 130, or the second electrode layer 120.

As such, in order for the protective layer to prevent (or reduce the likelihood of) the first electrode layer 110, the separator 130, or the second electrode layer 120 from wrinkling, a bending stiffness of the protective layer may be greater than an average bending stiffness of the first electrode layer 110, the separator 130, and the second electrode layer 120 (i.e., the average of the respective bending stiffness of the first electrode layer 110, the separator 130, and the second electrode layer 120). For example, a bending stiffness of the protective layer may be about 1.5 times greater than the average bending stiffness of the first electrode layer 110, the separator 130, and the second electrode layer 120.

Also, the protective layer may include (or be formed of) a material that has both a set stiffness and a set flexibility in order to not affect (e.g., negatively affect) the bending of the electrode assembly 100 (e.g., so that the flexibility of the electrode assembly is not unduly diminished). For example, the protective layer may include (or be formed as), but is not limited to, a polymer film, a film including a laminated polymer film layer, a metal foil, or a composite film including carbon. For example, the protective layer may have a thickness of about 15 micrometers to about 1 millimeter, and a tensile modulus of elasticity of the protective layer may be about 0.5 GPa to about 300 GPa.

The gasket 200 may surround the edge of the electrode assembly 100, may have an internal space having a central portion that is open and in which the electrode assembly 100 may be located, and may include (or be formed of) a flexible material. Accordingly, the gasket 200 may bend together with the electrode assembly 100 when the electrode assembly 100 bends, and thus may uniformly or substantially uniformly distribute a stress that is generated when the flexible secondary battery 10 bends, thereby preventing (or reducing) damage to the electrode assembly 100 due to concentration of the stress.

The gasket 200 may include, for example, a first layer 210, a second layer 230, and an intermediate layer 220A between the first layer 210 and the second layer 230, as shown in FIG. 4. The first layer 210 and the second layer 230 may be formed of the same material, and the intermediate layer 220A may be formed of a material that is different from that of the first layer 210 and the second layer 230.

The second sealing sheet 320 may be attached to the first layer 210 and the first sealing sheet 310 may be attached to the second layer 230. Accordingly, the first sealing sheet 310 and the second sealing sheet 320, together with the gasket 200, may seal the electrode assembly 100.

As shown in FIG. 4, the second sealing sheet 320 may include a first insulating layer 322, a metal layer 326, and a second insulating layer 324 that are sequentially stacked. Each of the first insulating layer 322 and the second insulating layer 324 may include (or be formed of), but is not limited to PP, polyethyleneterephthalate (PET), or nylon, and the metal layer 326 may include(or be formed of), but is not limited to, aluminum, steel, or stainless steel.

For example, the second sealing sheet 320 may have a three-layer structure including the first insulating layer 322 formed of PP, the metal layer 326 formed of aluminum, and the second insulating layer 324 formed of PET, wherein the first insulating layer 322 contacts (e.g., directly or physically contacts) the gasket 200.

The first insulating layer 322 may be attached to the first layer 210 by using thermal bonding. For example, in order to improve thermal bonding efficiency and increase a bonding force between the first insulating layer 322 and the first layer 210, the first layer 210 may be formed of the same or substantially the same material as that of the first insulating layer 322.

The first sealing sheet 310 may have the same structure as that of the second sealing sheet 320. For example, a first insulating layer of the first sealing sheet 310 may be attached to the second layer 230 by using thermal bonding. Accordingly, to improve thermal bonding efficiency between the first insulating layer of the first sealing sheet 310 and the second layer 230, the second layer 230 may be formed of the same or substantially the same material as that of the first insulating layer of the first sealing sheet 310, and the first layer 210 and the second layer 230 may be formed of the same or substantially the same material.

The intermediate layer 220A may have a modulus of elasticity that is different from that of each of the first layer 210 and the second layer 220. The intermediate layer 220A may include (or be formed of), for example, silicon, urethane, PET, or a shape memory alloy.

For example, when the intermediate layer 220A includes (or is formed of) silicon or urethane, the overall flexibility of the gasket 200 may be increased (or improved) because the intermediate layer 220A has a greater flexibility than the first layer 210 and the second layer 230 that may be formed of PP. Accordingly, a stress that is generated when the flexible secondary battery 10 bends may be uniformly or substantially uniformly distributed, thereby easily changing a shape of the flexible secondary battery 10.

The intermediate layer 220A may be attached to the first layer 210 and the second layer 230 by adhesive layers. For example, the gasket 200 may further include the adhesive layers between the first layer 210 and the intermediate layer 220A and between the second layer 230 and the intermediate layer 220A. Also, the first layer 210 and the second layer 230 may contact each other at an edge of the intermediate layer 220A. For example, the first layer 210 and the second layer 230 may surround the intermediate layer 220A.

Alternatively, when the intermediate layer 220A includes PET or a shape memory alloy having a higher modulus of elasticity than PP, a restoring force of the gasket 200 may be increased. Accordingly, a stress that is generated when the flexible secondary battery 10 bends may be uniformly or substantially uniformly distributed, and a shape of the flexible secondary battery 10 may be stably maintained even when the flexible secondary battery 10 is repeatedly bent. Also, when the intermediate layer 220A includes a shape memory alloy, the bent flexible secondary battery 10 may easily return to its pre-bent shape because of the shape memory alloy.

Alternatively, in some embodiments, as shown in FIG. 5, an intermediate layer 220B may include a first intermediate layer 222, a second intermediate layer 224 at (or on or formed on) a first surface of the first intermediate layer 222, and a third intermediate layer 226 at (or on or formed on) a second surface of the first intermediate layer 222. The first intermediate layer 222 may include (or be formed of) a shape memory alloy, and each of the second intermediate layer 224 and the third intermediate layer 226 may include (or,be formed of) silicon or PET.

For example, when the flexible secondary battery 10 bends in one direction, the bending characteristics of the flexible secondary battery may be further improved if the first intermediate layer 222 is formed of a shape memory alloy (e.g., with a high modulus of elasticity and a high restoring force), the second intermediate layer 224 or the third intermediate layer 226 that may contract is formed of silicon (e.g., so that the second intermediate layer 224 or the third intermediate layer 226 may be easily compressed), and the third intermediate layer 226 or the second intermediate layer 224 in which a tensile force is generated is formed of PET (e.g., so that the third intermediate layer 226 or the second intermediate layer 224 has a high modulus of elasticity).

The gasket 200 may be formed to have a thickness of about 80% to about 120% of a thickness of the electrode assembly 100, thereby preventing a bent portion from being formed at (or in) the first sealing sheet 310 and the second sealing sheet 320 (or thereby reducing a likelihood of formation of the bent portion).

If the bent portion is formed at (or in) the first sealing sheet 310 and the second sealing sheet 320, a stress may concentrate at (or on) the bent portion that is formed in the first sealing sheet 310 and the second sealing sheet 320 when the flexible secondary battery 10 bends, thereby damaging (e.g., tearing) the first sealing sheet 310 and the second sealing sheet 320.

However, according to an embodiment of the present invention, since the gasket 200 has (or is formed to have) a thickness of about 80% to about 120% of that of the electrode assembly 100, the bent portion may be prevented from being formed in the first sealing sheet 310 and the second sealing sheet 320 (or a likelihood of formation of the bent portion may be reduced) when the flexible secondary battery 10 bends and a stress may be uniformly or substantially uniformly distributed, (e.g., the stress is not concentrated at (or on) a specific portion or location of the first sealing sheet 310 and the second sealing sheet 320), thereby improving the stability of the flexible secondary battery 10.

A method of manufacturing the flexible secondary battery 10 will now be explained.

First, the second sealing sheet 320 is attached to the second surface of the gasket 200. The second sealing sheet 320 may be attached to the second surface of the gasket 200 such that the first insulating layer 322 faces the gasket 200 and then the first layer 210 of the gasket 200 and the first insulating layer 322 are thermally bonded to each other.

Next, the electrode assembly 100 is placed (or disposed) at (or in) the internal space of the gasket 200, and then the first sealing sheet 310 is attached to the first surface of the gasket 200. A method of attaching the first sealing sheet 310 is the same or substantially the same as a method of attaching the second sealing sheet 320. According to some embodiments, the order of attaching the second sealing sheet 320 and the first sealing sheet 310 may be reversed.

The first electrode tab 118 and the second electrode tab 128 of the electrode assembly 100 may protrude to the outside between the gasket 200 and the first sealing sheet 310, and, in order to increase a bonding force between the gasket 200 and the second sealing sheet 310 and to prevent a short circuit between the first electrode tab 118 and the second electrode tab 128 (or to reduce a likelihood of such short circuit), insulating films 150 may be attached to respective outer surfaces of the first electrode tab 118 and the second electrode tab 128 that overlap with the gasket 200.

Although the second sealing sheet 320 is described above as being first attached to the gasket 200 and then the first sealing sheet 310 is attached, the present embodiment is not limited thereto and the first sealing sheet 310 may be first attached, or the electrode assembly 100 may be placed (or disposed) at (or in) the gasket 200 and then the first sealing sheet 310 and the second sealing sheet 320 may be concurrently (e.g., simultaneously) or sequentially attached to the gasket 200.

As such, since the flexible secondary battery 10 of the present embodiment secures a space in which the electrode assembly 100 is received by using the gasket 200, a drawing work of forming a space in a pouch in which the electrode assembly 100 is received may be omitted.

Also, in other batteries, as a thickness of the electrode assembly 100 increases, a drawing work depth increases to correspond to the thickness of the electrode assembly 100, thereby increasing a risk of a crack forming in the pouch. In the flexible secondary battery 10 of embodiments of the present invention, however, since a thickness of the gasket 200 is freely determined according to a thickness of the electrode assembly 100, the flexible secondary battery 10 having a large capacity may be easily manufactured.

In addition, since the gasket 200 includes (or is formed of) a flexible material and has a structure in which materials having different moduli of elasticity are stacked, a stress that is generated when the flexible secondary battery 10 bends may be uniformly or substantially uniformly distributed, thereby maintaining the stability and reliability of the flexible secondary battery 10.

Table 1 shows the capacity retention rates of two flexible secondary batteries, herein named Comparative Example 1 and Comparative Example 2, respectively. The capacity retention rates were measured prior to bending, after bending 1000 times to a curvature radius of 25 mm, and after bending 2000 times to a curvature radius of 25 mm. Comparative Example 1 corresponds to a secondary battery where a receiving portion in which the secondary battery is received is formed in a pouch by using a drawing work and then the pouch outside the receiving portion is sealed by using thermal bonding. Comparative Example 2 corresponds to the flexible secondary battery 10 of FIG. 1, and wherein the gasket 200 has a single-layer structure formed of PP.

TABLE 1

| | Bending Cycles | | |
|---|---|---|---|
| | 0 | 1000 | 2000 |
| Comparative | 100% | 75.4% | 23.6% |
| Example 1 | | | |
| Comparative | 100% | 95.6% | 90.3% |
| Example 2 | | | |

As shown in Table 1, in Comparative Example 1, a capacity retention rate after 1000 bending cycles is reduced to 75.4% and is further greatly reduced to 23.6% after 2000 bending cycles. In contrast, in Comparative Example 2, a capacity retention rate is equal to or greater than 90% even after 2000 bending cycles. This is because the gasket 200 bends together with the flexible secondary battery 10 when the flexible secondary battery 10 bends, and thus a stress may be uniformly or substantially uniformly distributed, thereby preventing damage to the electrode assembly 100 (or reducing a likelihood of such damage).

FIG. 6 is a graph illustrating the capacity retention rates of various flexible secondary batteries after the batteries were repeatedly bent to a curvature radius of 25 mm. In FIG. 6, case A corresponds to the same secondary battery as Comparative Example 2 of Table 1, and cases B, C, and D correspond to embodiments of the present invention.

In detail, case A corresponds to the flexible secondary battery 10 of FIG. 1, wherein the gasket 200 has a single layer-structure formed of PP are used.

In contrast, case B corresponds to a flexible secondary battery 10 of FIG. 1, wherein the gasket 200 includes (or comprises) the first layer 210 and the second layer 230 each formed of PP and the intermediate layer 220A formed of silicon. Case C corresponds to a flexible secondary battery 10 of FIG. 1, wherein the gasket 200 includes (or comprises) the first layer 210 and the second layer 230 each formed of PP and the intermediate layer 220A formed of PET.

Also, case D corresponds to a flexible secondary battery 10 of FIG. 1, wherein the gasket 200 of FIG. 5 includes (or comprises) the intermediate layer 220B includes (or comprises) the first intermediate layer 222 formed of a shape memory alloy, the second intermediate layer 224 formed of PET, and the third intermediate layer 226 formed of silicon.

As shown in FIG. 6, cases B, C, and D each have a lower capacity reduction rate than case A. For example, when the gasket 200 has a structure in which materials having different moduli of elasticity are stacked, a stress that is generated when the flexible secondary battery 10 repeatedly bends may be more uniformly or substantially uniformly distributed, thereby further improving the reliability of the flexible secondary battery 10.

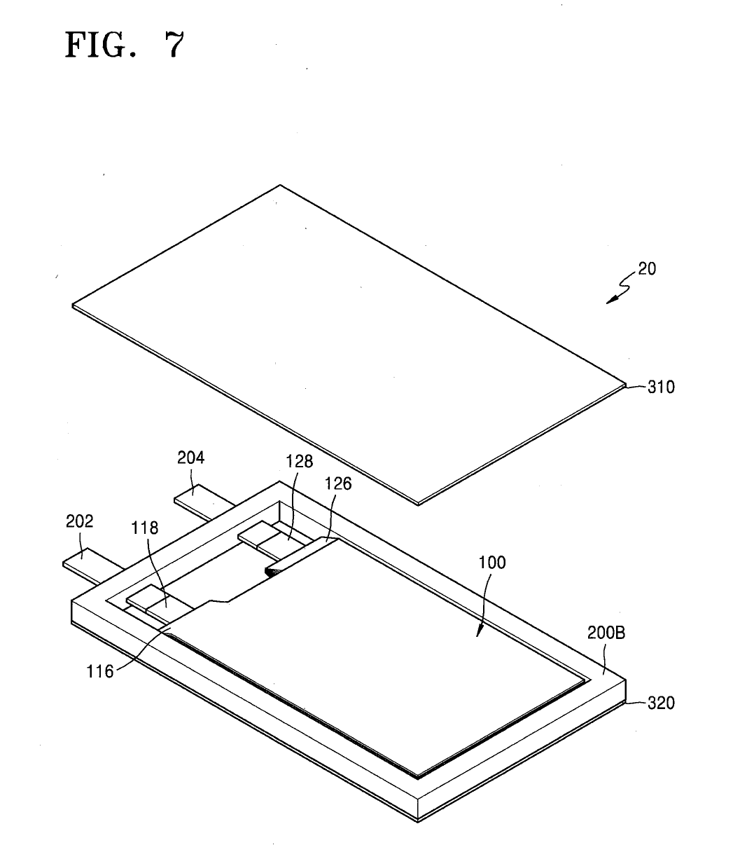

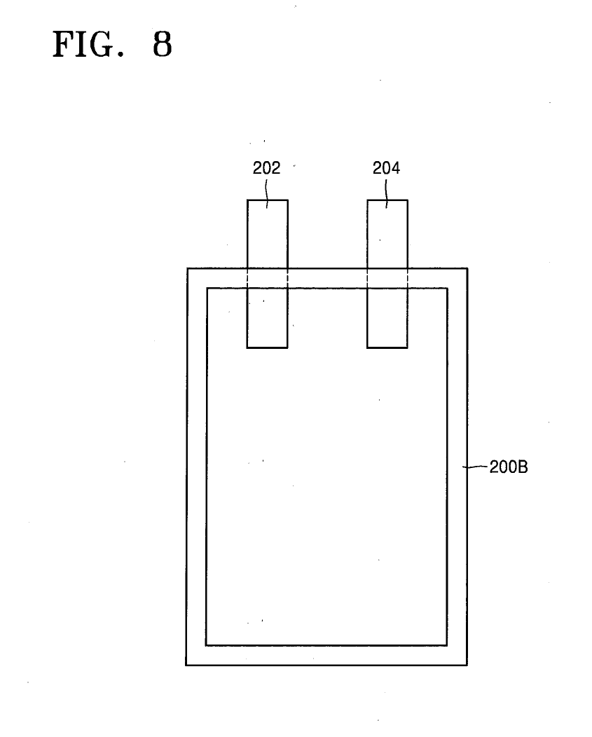

FIG. 7 is an exploded perspective view illustrating a flexible secondary battery 20 that is a modification of the flexible secondary battery 10 of FIG. 1 (e.g., another embodiment of the flexible secondary battery). FIG. 8 is a plan view illustrating a gasket 200B of the flexible secondary battery 20 of FIG. 7.

Referring to FIGS. 7 and 8, the flexible secondary battery 20 may include the electrode assembly 100, the gasket 200B that surrounds an edge of the electrode assembly 100, the first sealing sheet 310 that is attached to a first surface of the gasket 200B, and the second sealing sheet 320 that is attached to a second surface of the gasket 200B that is opposite to the first surface.

The electrode assembly 100, the first sealing sheet 310, and the second sealing sheet 320 are the same as those of FIGS. 1 through 5, and thus a the explanation thereof will not be repeated here.

The gasket 200B may surround the edge of the electrode assembly 100 and may include (or be formed of) a flexible material. Accordingly, the gasket 200B bends along with the electrode assembly 100 when the flexible secondary battery 20 bends, and thus may uniformly or substantially uniformly distribute a stress, thereby effectively preventing damage to the electrode assembly 100 (or reducing a likelihood or amount of such damage).

The gasket 200B may include a first lead electrode 202 and a second lead electrode 204 that pass through one side of the gasket 200B. The first lead electrode 202 and the second lead electrode 204 may be integrally formed with the gasket 200B by using insert molding.

The first lead electrode 202 may be attached to (e.g., adhered to) the first electrode tab 118 in an internal space of the gasket 200B, and the second lead electrode 204 may be attached to (e.g., adhered to) the second electrode tab 128 in the internal space of the gasket 200B. The first electrode tab 118 may be attached to (e.g., adhered to) the first non-coated portion 116 and the second electrode tab 128 may be attached to (e.g., adhered to) the second non-coated portion 126.

As such, when the first electrode tab 118 and the second electrode tab 128 are respectively connected to the first lead electrode 202 and the second lead electrode 204, the first electrode tab 118 and the second electrode tab 128 are connected to the outside without bending, thereby preventing damage to the first electrode tab 118 and the second electrode tab 128 (or reducing a likelihood or amount of such damage). Also, since the first electrode tab 118 and the second electrode tab 128 are not between the gasket 200B and the first sealing sheet 310 or the second sealing sheet 320, a bonding force between the gasket 200B and the first sealing sheet 310 or the second sealing sheet 320 may be increased.

A method of manufacturing the flexible secondary battery 20 is basically or substantially the same as the method of manufacturing the flexible secondary battery 10. However, when the electrode assembly 100 is placed (or disposed) at (or in) the internal space of the gasket 200B, the first electrode tab 118 and the second electrode tab 128 may be respectively attached to the first lead electrode 202 and the second lead electrode 204 by using welding or the like.

As described above, according to the one or more of the above embodiments of the present invention, a flexible secondary battery may maintain stability and reliability even after the flexible secondary battery repeatedly bends.

Other unmentioned effects of embodiments of the present invention will be apparent to one of ordinary skill in the art from the above description.

While the present invention has been particularly shown and described with reference to exemplary embodiments thereof using specific terms, the embodiments and terms have been used to explain the present invention and should not be construed as limiting the scope of the present invention defined by the claims.

Accordingly, it will be understood by those of ordinary skill in the art that various changes in form and details may be made therein without departing from the spirit and scope of the present invention as defined by the following claims, and equivalents thereof.

What is claimed is:

1. A flexible secondary battery comprising:
an electrode assembly comprising a first electrode layer, a second electrode layer, and a separator between the first electrode layer and the second electrode layer;
a flexible gasket surrounding an edge of the electrode assembly;
a first sealing sheet attached to a first surface of the gasket; and
a second sealing sheet attached to a second surface of the gasket facing away from the first surface,
wherein the gasket comprises a first layer and a second layer comprising materials that are the same, and an intermediate layer between the first layer and the second layer and comprising a material that is different from the material of the first layer and the second layer.

2. The flexible secondary battery of claim 1, wherein a modulus of elasticity of the intermediate layer is different from a modulus of elasticity of each of the first layer and the second layer.

3. The flexible secondary battery of claim 1, wherein the first layer and the second layer contact each other at an edge of the intermediate layer.

4. The flexible secondary battery of claim 1, further comprising adhesive layers between the first layer and the intermediate layer and between the second layer and the intermediate layer.

5. The flexible secondary battery of claim 1, wherein the gasket has a thickness of about 80% to about 120% of a thickness of the electrode assembly.

6. The flexible secondary battery of claim 1, wherein each of the first sealing sheet and the second sealing sheet comprises a first insulating layer, a metal layer, and a second insulating layer,
wherein the first insulating layer contacts the gasket, and the first insulating layer, the first layer, and the second layer comprise materials that are the same.

7. The flexible secondary battery of claim 1, wherein the intermediate layer comprises silicon, polyethyleneterephthalate (PET), urethane, or a shape memory alloy.

8. The flexible secondary battery of claim 1, wherein the intermediate layer comprises a first intermediate layer, a second intermediate layer on a first surface of the first intermediate layer, and a third intermediate layer on a second surface of the first intermediate layer,
wherein the first intermediate layer comprises a shape memory alloy, and each of the second intermediate layer and the third intermediate layer comprise silicon or PET.

9. The flexible secondary battery of claim 1, wherein the first electrode layer comprises a first active material unit, the first active material unit comprising a first metal current collector coated with a first active material,
and a first non-coated portion on which the first active material is not coated and to which a first electrode tab is attached, and
the second electrode layer comprises a second active material unit, the second active material unit comprising a second metal current collector coated with a second active material, and
a second non-coated portion on which the second active material is not coated and to which a second electrode tab is attached.

10. The flexible secondary battery of claim 9, wherein the first electrode tab and the second electrode tab protrude to the outside between the gasket and the first sealing sheet or between the gasket and the second sealing sheet.

11. The flexible secondary battery of claim 9, wherein the gasket comprises a first lead electrode and a second lead electrode passing through one side of the gasket.

12. The flexible secondary battery of claim 11, wherein the first lead electrode is attached to the first electrode tab and the second lead electrode is attached to the second electrode tab in an internal space of the gasket.

13. The flexible secondary battery of claim 1, wherein the electrode assembly further comprises a fixing member fixing one end portion of each of the first electrode layer, the separator, and the second electrode layer together.
